(19) United States
(12) Patent Application Publication
(10) Pub. No.: US 2006/0041624 A1
(43) Pub. Date: Feb. 23, 2006

(54) System and method for distributing an electronic message

(75) Inventors: Ruthie D. Lyle, Durham, NC (US); Veronique L. Moses, Raleigh, NC (US); Andrew L. Schirmer, Andover, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: International Business Machines Corporation, Armonk, NY (US)

(21) Appl. No.: 10/920,981

(22) Filed: Aug. 18, 2004

(51) Int. Cl. G06F 15/16

(52) U.S. Cl. 709/206

(57) ABSTRACT

A method and system for generating an individualized electronic message is described. The method includes receiving at an electronic message server a source message and generating a plurality of individualized electronic messages based upon an association between respective body portions of the source message and intended recipient groups. The source message includes a first body portion having a first group identifier and a second body portion having a second group identifier.

### FIELD OF THE INVENTION

The invention relates to distributing an electronic message. More specifically, the invention relates to distributing an individualized electronic message generated from select portions of a source message.

### BACKGROUND OF THE INVENTION

Current computerized messaging systems provide for the ability to send a computerized message to more than one recipient. Such systems are limited, however, in that each recipient receives the identical message. This is inconvenient, in a situation where it is desired to send a private comment to some but not all of the recipients. For example, in an electronic mail (“E-mail”) messaging system, the sender authors a text message, with or without attachments, that can be sent to recipients in any of three categories: a “To:” category, a “cc:” category, and a “bcc:” category. As is known, the “To:” category is for the directly-intended recipient or recipients, the “cc:” category is for courtesy-copy recipients who are included for information, and the “bcc:” category is for blind-courtesy-copy recipients who are intended to receive the message without other recipients being aware of their receipt. However, even with the above addressing categories, what is received by each recipient is the entire text of the message and all attachments. Thus, each recipient receives the identical message.

In some situations, the sender wishes to send or forward portions of a message only to a subset of the recipients. For example, a sender may desire to include private comments in the E-mail message that are readable only by bcc recipients. Since current E-mail systems send the identical message to every recipient, it is necessary for the sender to create two different E-mail messages and to select which message is to be sent to which recipient. This arrangement is cumbersome and time-consuming, and inevitably leads to errors such as private comments being read by unintended recipients.

### SUMMARY OF THE INVENTION

In general, the invention is directed to increasing the productivity of mass E-mail distribution by adding the ability to personalize portions of a source message for a specific individual or individuals based on criteria stored in a user registry. That is, the recipient-specific content of a message is dependent on a characteristic of the recipient, as provided in the registry, rather than by a list of static email addresses. The personal content of the source message includes textual content as well as other forms including but not limited to attached files, graphics, images, and audio and video content. Additionally, the personal content may be dynamically generated as a result of manipulations between one or more backend databases/systems that maybe correlated with entries in the user registry.

In one aspect, the invention features a method of generating an individualized electronic message. The method includes receiving at an electronic message server a source message including a first body portion having a first group identifier and a second body portion having a second group identifier, generating a first electronic message having the first body portion of the source message for a recipient of a recipient registry having the first group identifier, and generating a second electronic message having the second body portion of the source message for a recipient of the recipient registry having the second group identifier.

In another aspect, the invention features a computer system configured to generate an individualized electronic message. The computer system includes a processor and server messaging software executable by the processor. The server message software includes an analyzer, a user registry (can be external), and a composer. The analyzer is in communication with the user registry to analyze a source electronic message received from a client computer system to determine an association between an intended recipient group and a body portion of the source message. The composer is in communication with the analyzer and is adapted to generate an electronic message for each intended recipient of the intended recipient group as determined by parameters of the user registry having the body portion associated with the intended recipient group.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a client-server environment within which the present invention can be practiced.

FIG. 2 is a block diagram of an embodiment of the client system of FIG. 1.

FIG. 3 is a block diagram of an embodiment of the server system of FIG. 1

FIG. 4 is a graphical representation of a user registry entry of the user registry of FIG. 1.

FIG. 5 is a flow chart of an embodiment of a method for distributing an electronic message according to principles of the invention.

FIG. 6A is a graphical representation of an embodiment of a graphical composition user interface on the client system according to principles of the invention.

FIG. 6B is an example of a set of user registry entries.

FIG. 6C is a block diagram depicting the resulting electronic messages according the criteria contained in the graphical user interface and user registry entries of FIG. 6A and FIG. 6B.

### DETAILED DESCRIPTION

The present invention relates to software configured to distribute electronic messages. The messaging software includes client software and server software which can be stand-alone applications or integrated into an existing electronic messaging system. A user authors (i.e., creates) a source electronic message having various body portions intended for different groups of recipients. The client messaging software facilitates association of the various body portions of the source message with the intended groups of recipients to create group-specific associations. The server system receives the source message and analyzes the group specific associations with respect to a user registry to determine which users in the registry belong to the specified recipient groups. The server system generates an electronic message for each member in the user registry fulfilling the predetermined criteria of the specified recipient groups. The electronic message to each member includes the body portions associated with the specified recipient group to which that member belongs.

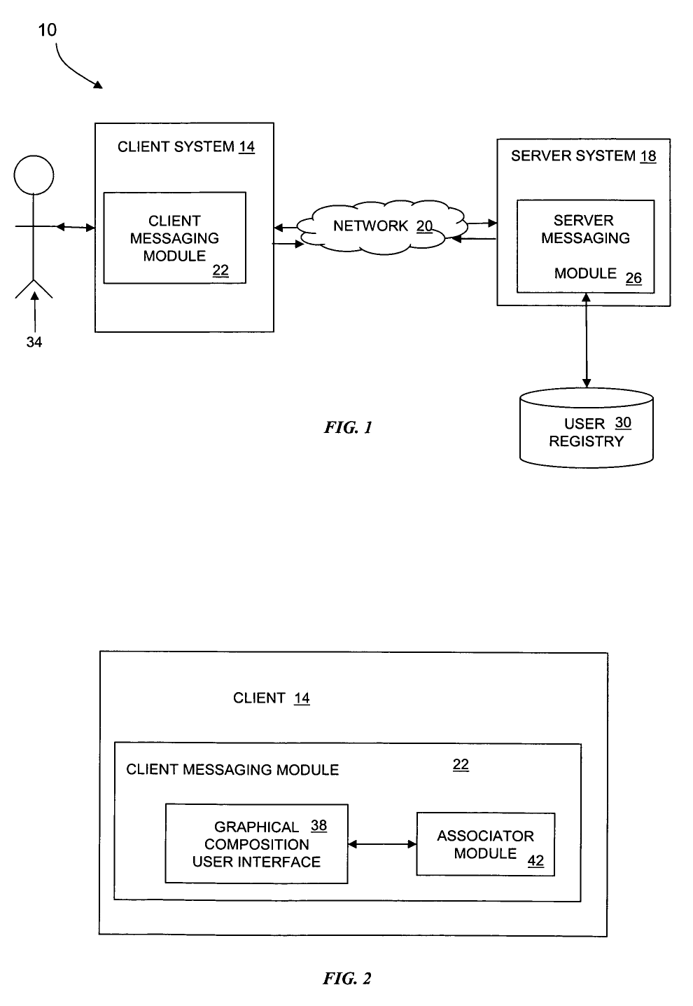

FIG. 1 shows an electronic messaging environment 10 in which the invention can be practiced. The electronic messaging environment 10 includes a client system 14 in communication with a server system 18 through a network 20. The client system 14 includes a client messaging module 22 in communication with various component of the client system 14. The server system 18 includes a server messaging module 26 in communication with various components of the server system 18 and a user registry 30.

The client system 14 can be any computing device, such as a personal computer, wireless device, information appliance, cell phone, personal digital assistant (PDA) or other computing device, that has hardware such as a display screen, one or more input devices (e.g., keypad, stylus, keyboard, mouse, touch-pad, and trackball), a processor for executing application programs and the client messaging module 22, and sufficient persistent storage for storing such application programs and related information.

The server system 18 can include a plurality of computing devices similar to those of the client system 14. Alternatively, the server system 18 can be a stand alone computing device. In one embodiment, the server system 18 is an electronic messaging server dedicated to processing electronic messages such as email.

The network 20 can be a local-area network (LAN), a metro-area network (MAN), or wide-area network (WAN), such as the Internet or World Wide Web. Users of the client system 14 can connect to the network 20 and in turn the server system 18 through one of a variety of connections, such as standard telephone lines, digital subscriber line, LAN or WAN links (e.g., T1, T3), broadband connections (Frame Relay, ATM), and wireless connections (e.g., 802.11(a), 802.11(b), 802.11(g)).

The user registry 30 includes various registry entries for storing information related to users of the electronic messaging environment 10. For example, a registry entry can include a phone number, a job title, and a location for each employee of a company. The user registry can be a database application resident on the server system 18 or located in a database separate from the server system 18. Alternatively, the user registry 30 can be an electronic messaging address book similar to those provided with electronic messaging applications such as LOTUS NOTES™ and MICROSOFT OUTLOOK™. In one embodiment, the user registry 30 is a global registry that stores identification parameters about each employee of a company.

During operation, a user 34 of client system 14 authors a source electronic message using the client system 14. The source electronic message includes at least one intended recipient group (e.g., a mailing list) and various body portions. To create an association between a specific body portion of the source message and an intended recipient group, the user 34 interacts with the client messaging module 22. Communications between the client system 14 and the server system 18 are established through the network 20. The source message is forwarded to the server system 18 and analyzed by the server messaging module 26 to determine which specific body portions are associated with which intended recipient group. Access to the user registry occurs and criteria defining the intended recipient group is compared against the user registry 30 to determine which registry entries are members of the intended recipient group. The server messaging module 26 creates and sends an electronic message having the specific body portion of the source messages associated with the intended recipient group to each person having a registry entry belonging to the intended recipient group.

FIG. 2 depicts an embodiment of the client messaging module 22 that executes on the client system 14. The client messaging module 22 includes a graphical composition user interface 38 in communication with an associator module 42. The graphical composition user interface 38 includes various windows for authoring the source electronic message. For example, the graphical composition user interface 38 can include addressing fields, such as a “To”, “cc”, and “bcc”, in one window, and a body composition window. Various intended recipient groups can be inserted into each of the respective addressing fields. Examples of the commercial applications that include graphical composition user interfaces 38 include, LOTUS NOTES™, MICROSOFT OUTLOOK™, and web based electronic messaging interfaces such as HOTMAIL™, EXCITE™, YAHOO MAIL™, and the like. Any other interface that allows the user 34 to create an electronic message can also be used.

The associator module 42 includes software code for associating the body portions of the source electronic message with respective intended recipient groups. In one embodiment, the software code of the associator module 42 creates a graphical user interface that facilitates the association of the body portions of the source message with respective intended recipient groups. The graphical user interface can include a list of the intended recipient groups that are present in the “To”, “cc”, and “bcc” fields of the graphical composition user interface 38.

The associator module 42 also includes software code for changing the appearance of the body portion of the source message once an association between the body portion and an intended recipient group occurs. For example, the font style, font size, and text color can by changed. Additionally, the associated body portion can be replaced with an icon. To access the replaced text, the recipient places a pointer (e.g., a mouse pointer) proximate to the icon to display a pop-up window that includes the body portion appears.

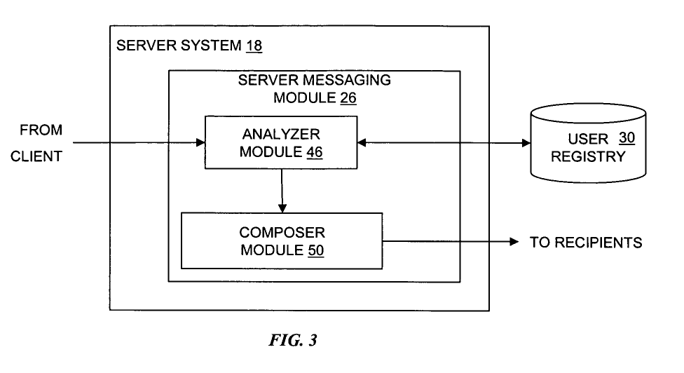

FIG. 3 depicts an embodiment of the server messaging module 26 that executes on the server system 18. The server messaging module 26 includes an analyzer module 46 in communication with a composer module 50 and the user registry 30.

The analyzer module 46 includes software code for analyzing the source electronic message to determine which body portions are intended for specific groups of recipients (private body portions) and which portions of the source electronic message are intended for all recipients (public body portions). Additionally, the analyzer module 46 includes software code for accessing the user registry 30 to determine which registry entries include parameters common to the intended group of recipients. For example, if the intended group of recipients is Managers, then each registry entry that is identified as a Manager is forwarded to the composer module 50.

The composer module 50 includes software code for generating an electronic message having recipient-specific content for each entry of the user registry 30 forwarded by the analyzer module 46. Also included in the composer module 50 is software code for copying the appropriate body portions of the source electronic message. The copied body portions are inserted into electronic messages to create a recipient-specific electronic message for each entry of the user registry 30.

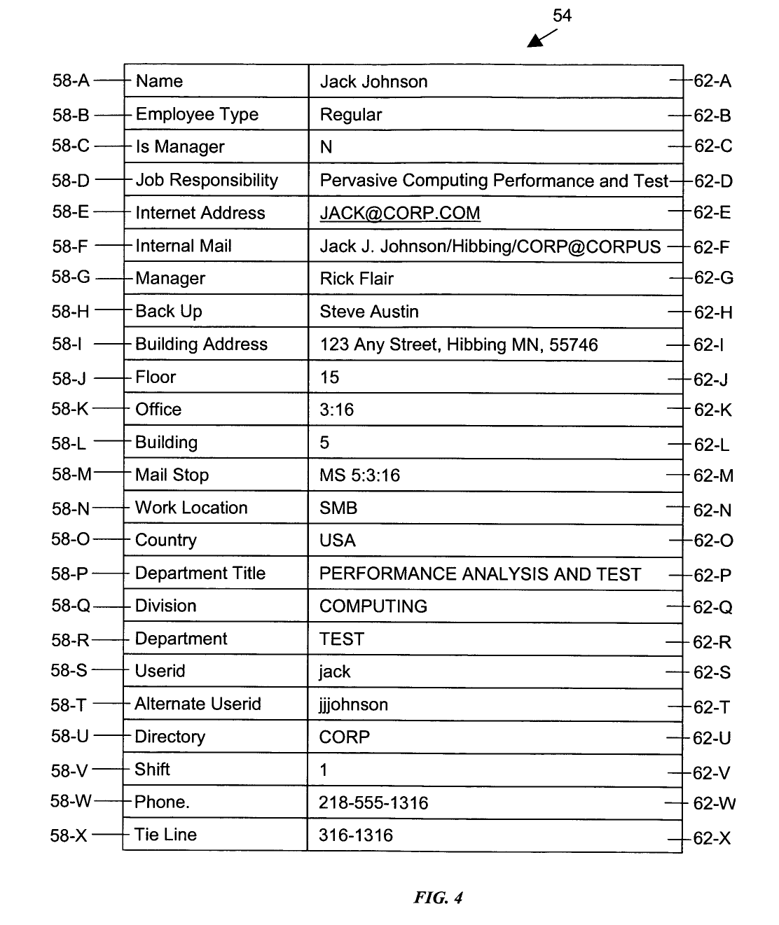

FIG. 4 depicts an example of a registry entry 54 stored in the user registry 30. The registry entry 54 includes a plurality of identification field labels 58-A to 58-X (referred to generally as identification field labels 58) to define parameter fields about an employee of a company. The user registry entry 54 also include a plurality of parameter fields 62-A to 62-X (referred to generally as parameter field 62) for storing identification parameters for the employee. For example, identification field label 58-Q and parameter field 62-Q indicate that the employee associated with the registry entry 54 is a member of the division known as computing. Each pair of identification field labels 58 and parameter fields 62 can be used to determine if a registry entry fulfills the criteria of the intended recipient group. For example, if the user 34 desires to send an electronic message to all employees of the 15^{th} floor the user inserts FLOOR15 into one of the addressing fields of the graphical composition user interface 38. Each registry entry having 15 in the parameter field 62-J and FLOOR in the identification field label 58-J belongs to the intended recipient group FLOOR15.

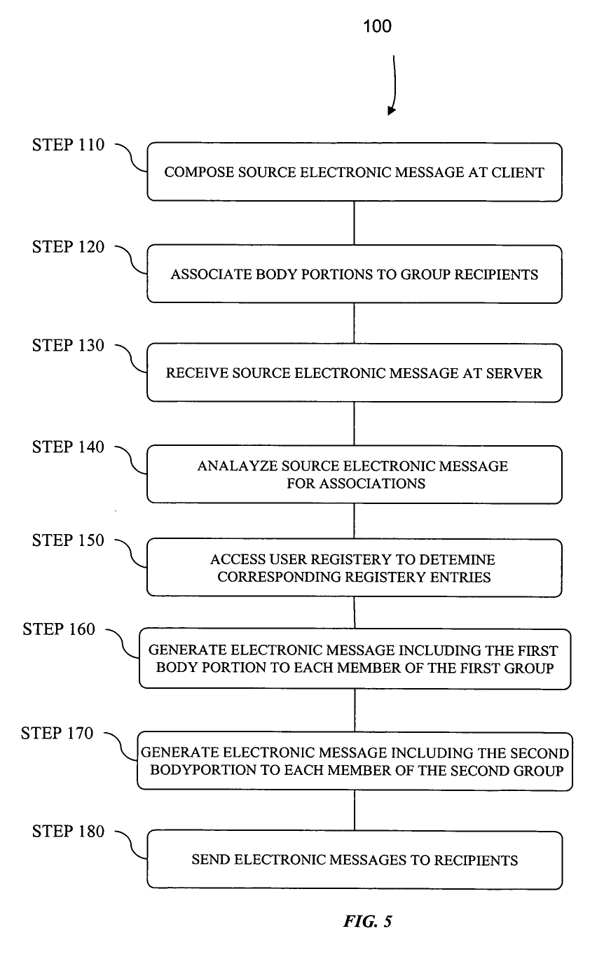

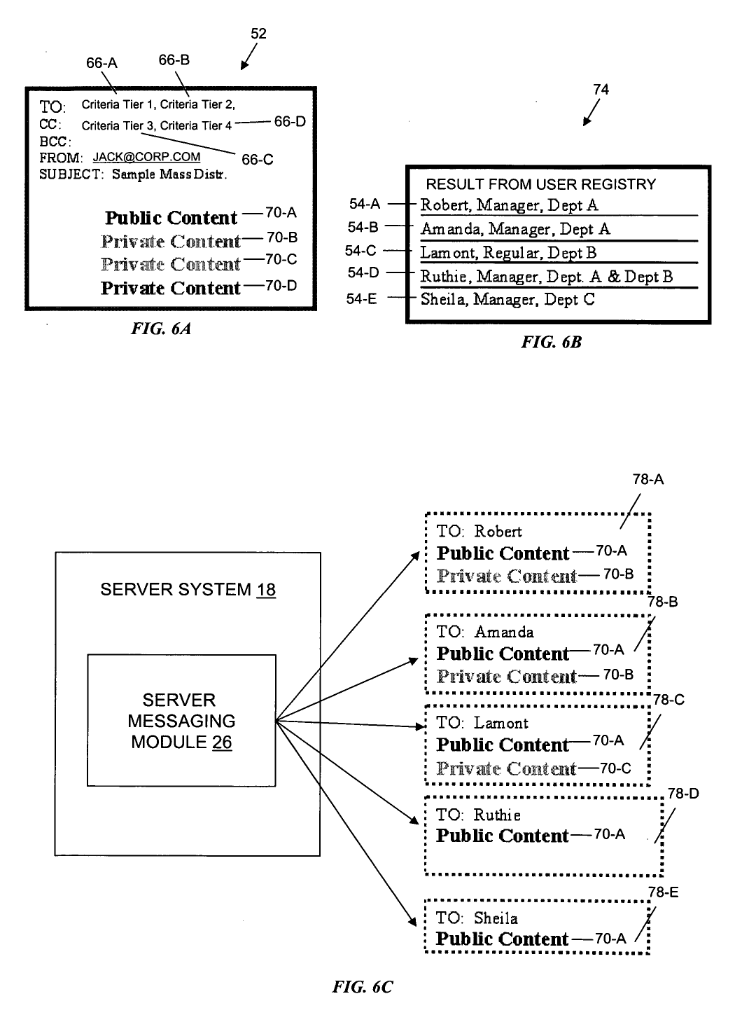

A detailed example of the operation of the client messaging module 22 and the server messaging module 26 is provided with reference to FIGS. 5, 6A, 6B, and 6C. In one embodiment of a method 100 of operation of the present invention, the user 34 interacts with the client messaging module 22 executing on the client system 14 to compose (step 110) the source message 52, as shown in FIG. 6A, using the graphical composition user interface 38. The intended recipient groups 66-A, 66-B, 66-C, 66-D of the source message 52 are defined by criteria related to the identification field labels 58 and the parameter fields 62 of the user registry entries 54. As shown, Criteria Tier 1 is the first intended recipient group 66-A, and is defined by “Manager+Regular+Dept. A

+Dept. B”. Each user registry entry 54 fulfilling any of these requirements receives any public content of the source message 52. Criteria Tier 2 is the second intended recipient group 66-B and is defined by “Manager+Dept. A”. Criteria Tier 3 is the third intended recipient group 66-C and is defined by “Regular+Dept. A+Dept. B”. Criteria Tier 4 is the fourth intended recipient group 66-D and is defined by “Manager+Regular+Dept. A”. The source message 52 includes a public body portion 70-A, a first private body portion 70-B, a second private body portion 70-C, and a third private body portion 70-D. The user 34 associates (step 120) each of the private body portions 70-B, 70-C, 70-D, with a respective Criteria Tier 66 using the associator module 42 of the client messaging module 22. In this example, private body portion 70-B is associated with Criteria Tier 2, private body portion 70-C is associated with Criteria Tier 3, and private body portion 70-D is associated with Criteria Tier 4. After association of the Criteria Tiers 66 and the private body portions 70-B, 70-C, 70-D occurs, the appearance of the private body potions 70-B, 70-C, 70-D changes. The public body portion 70-A, which is associated with Criteria Tier 1, remains unchanged.

It is possible to designate specific sections of any of the private body portions 70-B, 70-C, 70-D to different intended recipient groups 66. For example, if a value in private body portion 70-B is only to be viewed by Managers while the rest of the private body 70-B is viewable to all Managers and members of Dept. A, the user 34 can associate the value to one intended recipient group 66 and the rest of the private body portion to another intended recipient group 66. This ability provides a “nesting” feature that is part of the present invention.

The server messaging module 26 of the server system 18 receives (step 130) the source message 52. The analyzer module 46 of the server messaging module 26 analyzes (step 140) the source message 52 to determine if an association between a Criteria Tier 66 and body portion 70 exists. Also, the analyzer module 46 accesses (step 150) the user registry 30 to determine which entries 54 have the appropriate identification information in the parameter fields 62.

FIG. 6B shows a result 74 returned from the user registry 30. User registry entry 54-A for Robert fulfills Criteria Tier 1 and Criteria Tier 2 because the entry indicates he is a Manager and in Dept. A. User registry entry 54-B for Amanda also fulfills Criteria Tier 1 and Criteria Tier 2 because the entry indicates she is a Manager and in Dept. A. User registry entry 54-C for Lamont fulfills Criteria Tier 1 and Criteria Tier 3 because the entry indicates he is a Regular and in Dept. B. User registry entry 54-D for Ruthie fulfills only Criteria Tier 1, because the entry indicates she is a Manager and a member of Dept. A and Dept. B. User registry entry 54-E for Sheila only fulfills Criteria Tier 1, because the entry indicates she is a Manager and in Dept. C.

As shown in FIG. 6C, the server messaging module 26 generates (step 160) a first electronic messages 78-A addressed to Robert that includes the public body portion 70-A and the first private body portion 70-B and also generates (step 170) a second electronic message 78-B addressed to Amanda including the public body portion 70-A and the first private body portion 70-B. The server messaging software 26 also generates a third electronic message 78-C addressed to Lamont including the public body portion 70-A and the second private body portion 70-C, a fourth electronic message 78-D addressed to Ruthie including only the public body portion 70-A, and fifth electronic message addressed to Shelia having only the public body portion 70-A. Each of the electronic messages 78 includes user specific content that is defined by the association between the intended recipient groups 66 and the body portions 70. Each electronic message 78 is sent (step 180) to the intended recipient.

While the invention has been shown and described with reference to specific preferred embodiments, it should be understood by those skilled in the art that various changes in form and detail may be made therein without departing from the spirit and scope of the invention as defined by the following claims. Although described as a method and data file the invention can be embodied as instructions on a computer readable medium (e.g., compact disk, DVD, flash memory, and the like) that is sold and distributed in various commercial channels. Also, the instructions contained on the computer readable medium can be downloaded across a network (e.g., Internet). Additionally, the invention can be embodied as a computer data signal embodied in a carrier wave for generating an individualized electronic message.

What is claimed is:

1. A method of generating an individualized electronic message, comprising:
receiving at an electronic message server a source message including a first body portion having a first group identifier and a second body portion having a second group identifier;
generating a first electronic message having the first body portion of the source message for a recipient of a recipient registry having the first group identifier; and
generating a second electronic message having the second body portion of the source message for a recipient of the recipient registry having the second group identifier.

2. The method of claim 1 comprising:
composing the source message at a client; and
presenting to a user a graphical user interface to associate the first body portion of the source message with the first group identifier and to associate the second body portion of the source message with the second group identifier.

3. The method of claim 2 wherein the providing a graphical user interface comprises presenting a list of possible recipient groups to the user.

4. The method of claim 2 further comprising changing the appearance of the first body portion of the source message to indicate an association of the first group identifier with the first body portion.

5. The method of claim 4 wherein the changing the appearance comprises inserting an icon as a replacement for a portion of the first body portion.

6. The method of claim 5 further comprising displaying the first body portion to the user when a pointing device is proximate to the icon.

7. The method of claim 1 wherein the second electronic message includes at least the first and the second body portions of the source message.

8. A computer readable medium for generating an individualized electronic message, the computer readable medium comprising instructions to cause a processor to:
receive at an electronic message server a source message including a first body portion having a first group identifier and a second body portion having a second group identifier;
generate a first electronic message having the first body portion of the source message for a recipient of a recipient registry having the first group identifier; and
generate a second electronic message having the second body portion of the source message for a recipient of the recipient registry having the second group identifier

9. The computer readable medium of claim 8 further comprising instructions to cause a processor to:
compose the source message at a client; and
present to a user a graphical user interface to associate the first body portion of the source message with the first group identifier and to associate the second body portion of the source message with the second group identifier.

10. The computer readable medium of claim 9 wherein the instructions to provide a graphical user interface comprise instructions to present a list of possible recipient groups to the user.

11. The computer readable medium of claim 9 further comprising instructions to change the appearance of the first body portion of the source message to indicate an association of the first group identifier with the first body portion.

12. The computer readable medium of claim 11 wherein the instructions to change the appearance comprise instructions to insert an icon as a replacement for a portion of the first body portion.

13. The computer readable medium of claim 12 further comprising instructions to display the first body portion to the user when a pointing device is proximate to the icon.

14. The computer readable medium of claim 8 wherein the second electronic message includes at least the first and the second body portions of the source message.

15. A computer data signal embodied in a carrier wave for generating an individualized electronic message, the computer data signal comprising:
program code for receiving at an electronic message server a source message including a first body portion having a first group identifier and a second body portion having a second group identifier;
program code for generating a first electronic message having the first body portion of the source message for a recipient of a recipient registry having the first group identifier; and
program code for generating a second electronic message having the second body portion of the source message for a recipient of the recipient registry having the second group identifier.

16. The computer data signal of claim 15 further comprising:
program code for composing the source message at a client; and
program code for presenting to a user a graphical user interface to associate the first body portion of the source message with the first group identifier and to associate the second body portion of the source message with the second group identifier.

17. The computer data signal of claim 16 further comprising program code for changing the appearance of the first body portion of the source message to indicate an association of the first group identifier with the first body portion.

18. An apparatus for generating an individualized electronic message, the apparatus comprising:
means for receiving at an electronic message server a source message including a first body portion having a first group identifier and a second body portion having a second group identifier;
means for generating a first electronic message having the first body portion of the source message for a recipient of a recipient registry having the first group identifier; and
means for generating a second electronic message having the second body portion of the source message for a recipient of the recipient registry having the second group identifier.

19. The apparatus of claim 18 further comprising:
means for composing the source message at a client; and
means for presenting to a user a graphical user interface to associate the first body portion of the source message with the first group identifier and to associate the second body portion of the source message with the second group identifier.

20. The apparatus of claim 19 further comprising means for changing the appearance of the first body portion of the source message to indicate an association of the first group identifier with the first body portion.

21. A computer system configured to generate an individualized electronic message, the computer system comprising:
a processor configured to execute computer readable instructions; and
server messaging software executable by the processor including:
an analyzer in communication with a user registry to analyze a source electronic message received from a client computer system to determine an association between an intended recipient group and a body portion of the source message; and
a composer in communication with the analyzer adapted to generate an electronic message for each intended recipient of the intended recipient group as determined by parameters of the user registry having the body portion associated with the intended recipient group.

22. The computer system of claim 21 further comprising the client system having a processor configured to execute computer readable instructions; and
client messaging software executable by the processor including:
graphical composition user interface adapted to author the source message; and
an associator module adapted to provide a graphical interface to associate the body portion of the source message with the intended recipient group.
